(19) United States
(12) Patent Application Publication
(10) Pub. No.: US 2009/0071355 A1
(43) Pub. Date: Mar. 19, 2009

(54) PRINTING UNIT OF A WEB-FED ROTARY PRINTING PRESS

(75) Inventor: Wolfgang KAESER, Mertingen (DE)

Correspondence Address: CROWELL & MORING LLP;INTELLECTUAL PROPERTY GROUP, P.O. BOX 14300, WASHINGTON, DC, 20044-4300, US

(73) Assignee: manroland AG, Offenbach/Main (DE)

(21) Appl. No.: 12/209,919

(22) Filed: Sep. 12, 2008

(30) Foreign Application Priority Data
Sep. 14, 2007 (DE) 10 2007 043 841.0

(51) Int. Cl. B41F 5/04

(52) U.S. Cl. 101/219

(57) ABSTRACT

A printing unit of a web-fed rotary printing press with several printing couples is disclosed. Each printing couple features a transfer cylinder, a plate cylinder, an inking couple and preferably a dampening unit, where the transfer cylinder and the plate cylinder of each printing couple are positioned jointly on side walls of a frame of the printing unit, and where the printing unit is aligned in the web-fed rotary printing press via bearing devices which engage on the frame of the printing unit. Rollers of the inking couples and/or dampening units of the printing couples are positioned on separate supporting walls such that the supporting walls are displaceable with respect to the side walls on which the transfer cylinders and plate cylinders of the printing couples are positioned, in order to facilitate access to the cylinders and the rollers of the printing couples.

This application claims the priority of German Patent Document No. 10 2007 043 841.0, filed Sep. 14, 2007, the disclosure of which is expressly incorporated by reference herein.

### BACKGROUND AND SUMMARY OF THE INVENTION

The invention relates to a printing unit of a web-fed rotary printing press.

Printing units of web-fed rotary printing presses, in particular of newspaper printing presses or even commercial web printing presses, normally have several printing couples, wherein each printing couple is comprised of at least one transfer cylinder, one plate cylinder and one inking couple as well as preferably one dampening unit. Printing couples without dampening units are also known. In addition, these types of printing units can also have impression cylinders, which are also designated as satellite cylinders, wherein such an impression cylinder can cooperate with one or more transfer cylinders of different printing couples. Besides printing units that have these types of impression cylinders, printing units that do not have any impression cylinders are known, wherein, in the case of these types of printing units without impression cylinders, the transfer cylinders of two printing couples roll off of one another. The transfer cylinders are also designated as blanket cylinders and the plate cylinders as engraving cylinders. The plate cylinders or engraving cylinders bear printing plates.

Particularly in the case of newspaper printing presses, a trend has been noted that printing units with increasingly lower construction heights are in demand. The lower the construction height of a printing unit is, the wider such a printing unit is, whereby ultimately a person working on the printing unit, namely a printer, has trouble performing operational and maintenance tasks, such as changing a printing plate or a blanket, for example, on the plate cylinders of the printing units or even on the transfer cylinders of the same.

Separating the printing units into modules is already known in practice in order to nevertheless facilitate access particularly to the cylinders of the printing unit in the case of these types of printing units with a low construction height but with a large width. Thus, the printing units are separated, for example, into cylinder modules and inking couple modules, wherein, in the region of each printing couple of a printing unit, the entire inking couple can be displaced relative to the plate cylinder as well as to the transfer cylinder.

In the case of printing units known from practice in which the entire inking couple can be displaced relative to the plate cylinder as well as to the transfer cylinder of the corresponding printing couple, the side walls of a frame of the printing unit are also divided. In this case, it is then necessary to separately position and thereby align, on the one hand, the module having the plate cylinders as well as transfer cylinders and, on the other hand, the modules having the inking couples as well as any applicable dampening units in the web-fed rotary printing press via corresponding bearing devices, which engage on the respective module. This is particularly complicated structurally.

Starting herefrom, the present invention is based on the objective of creating a novel printing unit of a web-fed rotary printing press. According to the invention, rollers of the inking couples and/or dampening units of the printing couples are positioned on separate supporting walls in such a way that the supporting walls for the rollers of the inking couples and/or dampening units are displaceable with respect to the side walls, on which the transfer cylinders and plate cylinders of the printing couples are positioned, in order to facilitate access to the cylinders and the rollers of the printing couples.

The inventive printing unit is also divided into several modules, namely into one module with the plate cylinders and transfer cylinders of the printing couples and into modules with the inking couples and any applicable dampening units, wherein, however, the side walls of the frame of the printing unit are not divided.

In fact, the rollers of the inking couples and/or dampening units are positioned on separate supporting walls, which for their part are positioned displaceably on the side walls, so that the inking couples and/or dampening units can be displaced relative to the plate cylinders and transfer cylinders of the respective printing couples. Due to the fact that the inking couples and/or dampening units are positioned via the supporting walls on the side walls of the printing unit, in contrast to the prior art, it is not required, in the case of the inventive printing unit, for the modules with the inking couples and/or dampening units to keep separate bearing devices ready. In fact, only the entire printing unit as such must be positioned and aligned in the web-fed rotary printing press via bearing units. The structural expense can be clearly reduced as a result.

Advantageous developments of the invention are disclosed in the following description. Without being limited hereto, exemplary embodiments of the invention are explained in greater detail on the basis of the drawings.

### BRIEF DESCRIPTION OF THE DRAWINGS

FIG. 1 is a schematic side view of an inventive printing unit of a web-fed rotary printing press; and

FIG. 2 is a schematic top view of the inventive printing unit.

### DETAILED DESCRIPTION OF THE DRAWINGS

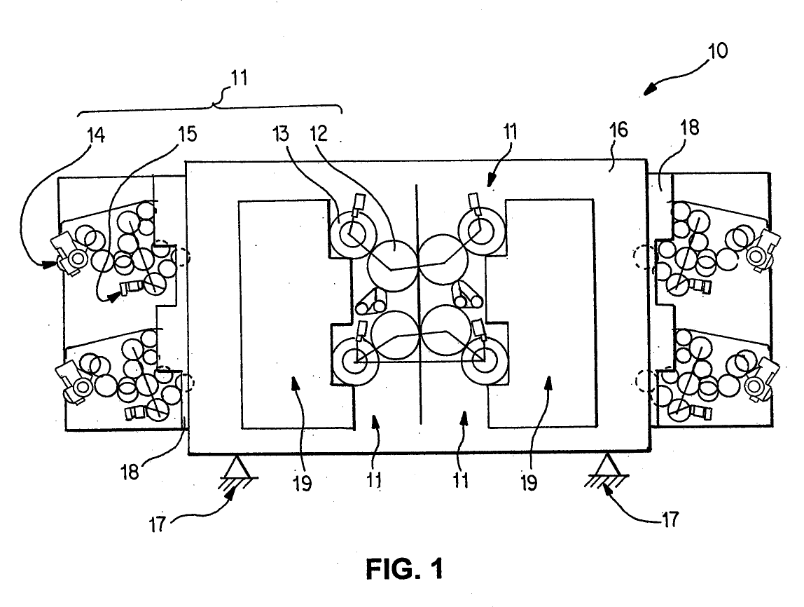

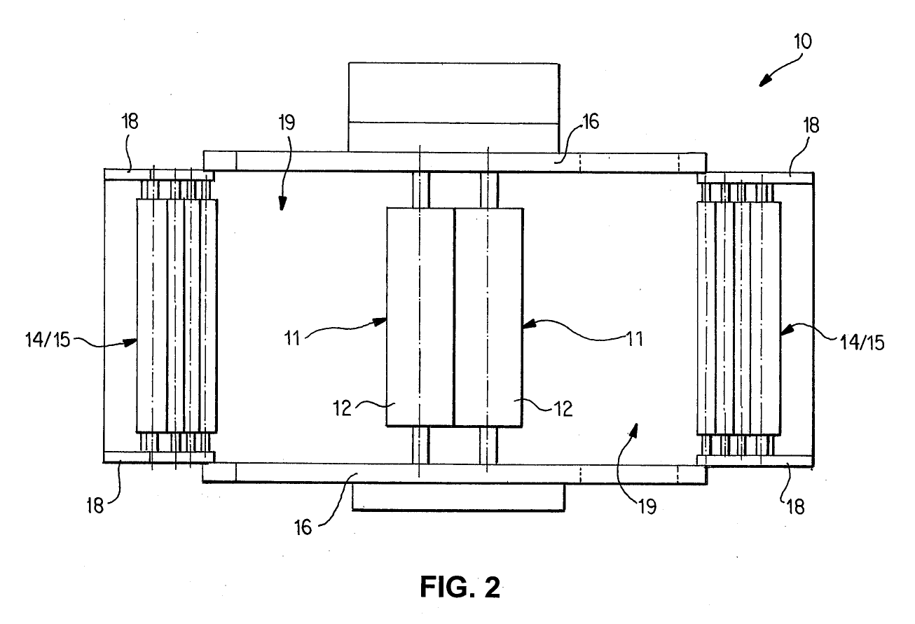

FIGS. 1 and 2 depict different views of an inventive printing unit 10 of a web-fed rotary printing press, wherein the inventive printing unit 10 is comprised of a total of four printing couples 11. Each printing couple 11 is comprised of a transfer cylinder 12, a plate cylinder 13, an inking couple 14 and a dampening unit 15. The transfer cylinders 12 of two respective printing couples 11 positioned horizontally side-by-side roll off forming a nip for a to-be-printed printing substrate. The printing unit 10 in FIGS. 1 and 2 is consequently an 8-cylinder printing unit.

The printing unit 10 depicted in FIGS. 1 and 2 is a printing unit that has a relatively low construction height, but a relatively great width. In order to guarantee good access to the cylinders and rollers with this type of printing unit 10, the inventive printing unit 10 is separated into modules, wherein the type of separation of the printing unit 10 into the individual modules constitutes the core of the present invention.

Within the scope of the present invention, the transfer cylinders 12 as well as plate cylinders 13 of all printing couples 11 of the inventive printing unit 10 are combined into a module and positioned on side walls 16 of a frame of the printing unit 11. Bearing devices 17 engage on the frame of the printing unit according to FIG. 1 in order to align the printing unit 10 within the web-fed rotary printing press.

The inking couples 14 as well as the dampening units 15 of two respective printing couples 11 positioned in a stacked manner are combined into one module, wherein the rollers of these inking couples 14 and dampening units 15 of the printing couples are positioned on separate supporting walls 18 in such a way that the supporting walls 18 for the rollers of the inking couples 14 and dampening units 15 are displaceable with respect to the side walls 16, on which the transfer cylinders 12 and plate cylinders 13 are positioned, in order to then create a free space 19 between the inking couples/dampening units as well as the plate cylinders/transfer cylinders so that the cylinders and rollers are easily accessible for maintenance work.

In the case of the inventive printing unit 10, the side walls 16 are thus not divided, in fact there are separate supporting walls 18, which are positioned displaceably on the side walls 16, to support the inking couples 14 as well as the dampening units 15.

In the exemplary embodiment in FIGS. 1 and 2, the supporting walls 18, on which the rollers of the inking couples 14 and dampening units 15 are positioned, are displaceable with respect to the side walls 16 of the frame of the printing unit in a direction perpendicular to the longitudinal center axis of the transfer cylinders 12. In contrast to this, it is also possible for the inking couples and the dampening units to be displaceable parallel to the longitudinal center axis of the transfer cylinders.

Due to the inventive design of the printing unit, the inking couples 14 as well as the dampening units 15 are displaceable as a whole with respect to the transfer cylinders 12 and plate cylinders 13 of the printing couples 11, wherein, however, separate bearing devices for the inking couples 14 and dampening units 15 are not required, in fact, the inking couples and the dampening units can be aligned in the web-fed rotary printing press via the bearing devices 17 that are already engaging on the frame of the printing unit 1

It is expressly emphasized that the invention is not restricted to printing presses having an eight-cylinder blanket-to-blanket arrangement, but also extends to satellite arrangements.

### LIST OF REFERENCE NUMBERS

10 Printing unit
11 Printing couple
12 Transfer cylinder
13 Plate cylinder
14 Inking couple
15 Dampening unit
16 Side wall
17 Bearing device
18 Supporting wall
19 Free space

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing unit of a web-fed rotary printing press comprising several printing couples, wherein each printing couple features a transfer cylinder, a plate cylinder, an inking couple and a dampening unit, wherein the transfer cylinder and the plate cylinder of each printing couple are positioned jointly on side walls of a frame of the printing unit, wherein the printing unit is alignable in the web-fed rotary printing press via bearing devices which engage on the frame of the printing unit, and wherein rollers of the inking couples and/or dampening units of the printing couples are positioned on separate supporting walls such that the supporting walls for the rollers of the inking couples and dampening units are displaceable with respect to the side walls on which the transfer cylinders and plate cylinders of the printing couples are positioned, such that an access space is defined between the cylinders and the rollers of the printing couples.

2. The printing unit according to claim 1, wherein the rollers of the inking couples and dampening units that are positioned on the separate supporting walls are alignable in the web-fed rotary printing press via the side walls of the frame of the printing unit and, thus, via the bearing devices engaging on the frame.

3. The printing unit according to claim 1, wherein the inking couples and dampening units are translatorily displaceable.

4. The printing unit according to claim 3, wherein the inking couples and dampening units are translatorily displaceable perpendicular to a longitudinal center axis of the transfer cylinders.

5. The printing unit according to claim 3, wherein the inking couples and dampening units are translatorily displaceable parallel to a longitudinal center axis of the transfer cylinders.

6. A printing unit of a web-fed rotary printing press, comprising:
a printing couple including a transfer cylinder, a plate cylinder, an inking couple and a dampening unit;
wherein the transfer cylinder and the plate cylinder are positioned on side walls of a frame of the printing unit wherein bearing devices engage on the frame of the printing unit;
and wherein rollers of the inking couple and the dampening unit are positioned on supporting walls and wherein the supporting walls are displaceable with respect to the side walls.

7. The printing unit according to claim 6, wherein an access space is defined between the cylinders and the rollers.

8. The printing unit according to claim 6, wherein the inking couple and dampening unit are translatorily displaceable.

9. The printing unit according to claim 8, wherein the inking couple and dampening unit are translatorily displaceable perpendicular to a longitudinal center axis of the transfer cylinder.

10. The printing unit according to claim 8, wherein the inking couple and dampening unit are translatorily displaceable parallel to a longitudinal center axis of the transfer cylinder.
